(19) United States
(12) Patent Application Publication
(10) Pub. No.: US 2004/0080928 A1
(43) Pub. Date: Apr. 29, 2004

(54) Chemiluminescent device cover

(76) Inventor: R. J. Knoll, Sherman Oaks, CA (US)

Correspondence Address: Matthew J. Cohen, 640 9th Ave, Menlo Park, CA, 94025, US

(21) Appl. No.: 10/279,301

(22) Filed: Oct. 23, 2002

(51) Int. Cl. F21K 2/00

(52) U.S. Cl. 362/34

(57) ABSTRACT

A chemiluminescent device cover (10) having a hollow envelope (12) which has a translucent envelope outer layer (12C) manufactured from a fluorescing material and a perforated envelope inner layer (12D) securely attached to the envelope outer layer (12C). The fluorescing outer layer (12C) functions to receive light emanating through the perforations in the envelope inner layer (12D) from a chemiluminescent within the envelope (12) and re-emanate the light therefrom.

### BACKGROUND OF THE INVENTION

1. Field of the Invention

The present invention relates to chemiluminescent device cover. More particularly, the present invention relates to chemiluminescent device cover having a fluorescing envelope outer layer.

2. Description of the Prior Art

Numerous innovations for covers have been provided in the prior art that are described as follows. Even though these innovations may be suitable for the specific individual purposes to which they address, they differ from the present invention as hereinafter contrasted.

In U.S. Pat. No., 6,033,080, titled, Emergency light operable on the lever principle, invented by Hasegawa, et. al., an emergency light includes a chemiluminescent light stick which can be easily operated to illuminate and taken out. When an operating lever is pushed, an engaging portion of a pivoting member pushes the bottom portion of the chemiluminescent light stick toward a wall surface. The chemiluminescent light stick has on the top end thereof a head secured to a holding hook of a holding member. The chemiluminescent light stick can be easily bent to illuminate by the lever principle with the protuberance of a case body serving as a fulcrum and the engaging portion serving as the point of action. When the operating lever is further pushed, the top end of the pivoting member protrudes frontward to open a top cover, and at the same time, the holding member which has been restricted by the pivoting member is released and it moves upward by the urging force of a flat spring and the pressing force applied by the head of the chemiluminescent light stick, thus enabling the chemiluminescent light stick to be removed.

In U.S. Pat. No., 5,043,851, titled, Polygonal chemiluminescent lighting device, invented by Kaplan, a polygonal outer shell providing improved light transmission characteristics for chemiluminescent lighting devices. The corners created by incidence of the surfaces that comprise the shell create a fiber optic effect by concentrating the light in the corners, thus enhancing visibility of light emanating from the light stick and optimizing the amount and distribution of light radiated from the device. Furthermore, a hook-shaped tip by which the light may be suspended from means of horizontal support. In an alternate embodiment, the hook defines an opening and a quick release locking device which allows quick insertion of means of horizontal support into the eye and simultaneously prevents the support from disengaging therefrom unless the locking device is released.

In U.S. Pat. No., 4,930,776, titled, Game ball, invented by Newcomb, et. al., the present invention takes the WIFFLE RTM BALL baseball into the darkness and allows for the continued play, without need of any complicated or expensive lighting equipment or the like. The standard WIFFLE.RTM. BALL baseball design is retained, and instead of traditional white plastic, a translucent plastic material is employed in the construction of the ball. Inserted into the ball for night play is an activated chemiluminescent light stick, such as those manufactured by, or under license from, the American Cyanamid Company and sold under the trademark CYALUME.RTM. The light stick used herein is an elongated flexible tubular member, joined at its ends with a connecting piece forming a circular light-ring. The light ring is readily inserted into the cavity of the translucent WIFFLE.RTM. BALL baseball and retained therein without the need of any special attachments or further modifications. Under field testing, the thus modified NITELITE WIFFLE.RTM. BALL baseball performed like a traditional white plastic WIFFLE.RTM. BALL baseball, and the light-ring provided ample visible light for about 4-6 hours.

In U.S. Pat. No., 4,695,055, titled, Illuminated translucent golfball, invented by Newcomb, et. al., a dimpled golf ball for use after dark. The ball is made of translucent plastic and contains in a diametrical hole therein a chemiluminescent light stick which when activated renders the ball when used in the dark plainly visible in the air and on the ground. In a preferred form, the ball is made to comply with the rules of the United States Golf Association so that it may also be used for competitive daytime play. In a modified form, the resilience of the ball may be substantially diminished so that it will travel a much less distance than the preferred ball when hit with the same club.

In U.S. Pat. No., 4,649,660, titled, Fishing float assembly, invented by Kurka, et. al., a fishing float assembly for use with a fishing line, and having a chemiluminescent light stick assembled thereto, is provided. The fishing float is a standard fishing float, having an upstanding substantially rigid circular neck at its top, to which is assembled an attachment portion. The attachment portion comprises a body having a sleeve in its lower end, where the sleeve has one or a plurality of slits formed along its length, and has a collar fitted over the sleeve. Either or both of the sleeve and collar may have sloping faces such that downward movement of the collar along the sleeve causes the sleeve to constrict and thereby grip the neck portion ofthe float. At the upper end of the body of the attachment portion, a socket is formed and dimensioned so as to grippingly retain a chemiluminescent light stick when placed therein. The light sticks are, themselves, available in the market, and have standard and constant dimensions.

In U.S. Pat. No., 4,563,726, titled, Illuminated chemiluminescent drinking mug, invented by Newcomb, et. al., a one piece illuminated drinking mug made of light permeable plastic, the mug wall being generally tubular with a flat bottom and having an axially disposed light permeable tube attached integrally to the bottom, the tube being longer than one half the vertical dimension of the mug, the tube being closed at its upper end and open at its lower end, said tube adapted to receive a light stick, and means for temporarily maintaining said light stick within said tube.

The aforementioned patents differ from the present invention because they lack one or more of the features of the present invention as follows: a chemiluminescent or luminescent stick, necklace, bracelet, ring, etc. which glows in the dark; translucent fabric, material and/or faux fur covering the chemiluminescent stick; and optional scenting.

Numerous innovations for covers have been provided in the prior art that are adapted to be used. Even though these innovations may be suitable for the specific individual purposes to which they address, they would not be suitable for the purposes of the present invention as heretofore described.

### SUMMARY OF THE INVENTION

The present invention relates to chemiluminescent device cover. More particularly, the present invention relates to chemiluminescent device cover having a fluorescing envelope outer layer.

The types of problems encountered in the prior art are chemiluminescent devices lack an outer covering enabling them to change light color and aesthetic appearance.

In the prior art, unsuccessful attempts to solve this problem were attempted namely: various configurations of covers. However, the problem was solved by the present invention because it incorporated an inner perforated layer and an outer fluorescent layer.

Innovations within the prior art are rapidly being exploited in the field of chemiluminescent devices.

The present invention went contrary to the teaching of the art which describes and claims plain covers.

The present invention solved a long felt need for an aesthetic cover which is capable of changing light color of the chemiluminescent device.

Accordingly, it is an object of the present invention to provide a chemiluminescent device cover having an envelope.

More particularly, it is an object of the present invention to provide an envelope having an envelope flap, envelope fastener, envelope outer layer, and envelope inner layer.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### LIST OF REFERENCE NUMERALS UTILIZED IN THE DRAWINGS

10-chemiluminescent device cover (10)

12-envelope (12)

12A-envelope flap (12A)

12B-envelope fastener (12B)

12C-envelope outer layer (12C)

12D-envelope inner layer (12D)

### BRIEF DESCRIPTION OF THE DRAWINGS

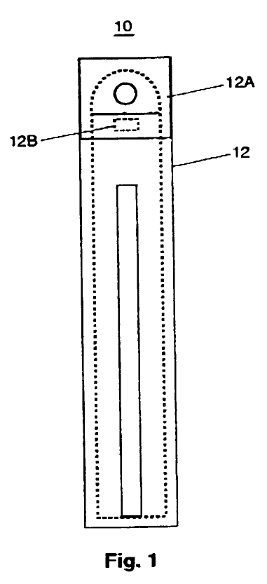

FIG. 1 is a side view of a chemiluminescent device cover (10) encasing a chemiluminescent.

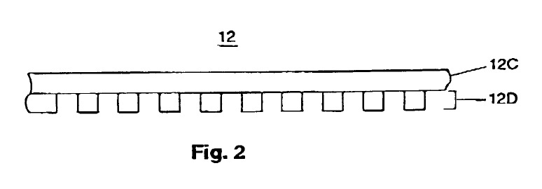

FIG. 2 is a cross sectional view of an envelope (12).

### DESCRIPTION OF THE PREFERRED EMBODIMENT

Referring to FIG. 1 which is a side view of a chemiluminescent device cover (10) encasing a chemiluminescent. The chemiluminescent device is selected from a group consisting of stick, necklace, bracelet, and ring.

Now referring to FIG. 2 which is a cross sectional view of an envelope (12). The chemiluminescent device cover (10) comprises a hollow envelope (12) having a translucent envelope outer layer (12C) manufactured from a fluorescing material and a perforated envelope inner layer (12D) securely attached to the envelope outer layer (12C). The fluorescing outer layer (12C) functions to receive light emanating through the perforations in the envelope inner layer (12D) from a chemiluminescent within the envelope (12) and re-emanate the light therefrom. The envelope (12) preferably further comprises at least one envelope flap (12A) positioned at a distal end functioning to enclose the chemiluminescent therein. The envelope (12) preferably further comprises an envelope fastener (12B) to attach the at least one envelope flap (12A) thereto. The envelope (12) is manufactured from a material selected from a group consisting of fuzzy fabric, faux fur, plastic, and plastic composite.

It will be understood that each ofthe elements described above, or two or more together, may also find a useful application in other types of constructions differing from the type described above.

While the invention has been illustrated and described as embodied in a cover, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A chemiluminescent device cover (10) comprising:
A) a hollow envelope (12) which comprises a translucent envelope outer layer (12C) manufactured from a fluorescing material and a perforated envelope inner layer (12D) securely attached to the envelope outer layer (12C).

2. The chemiluminescent device cover (10) as described in claim 1, wherein the envelope (12) further comprises at least one envelope flap (12A) positioned at a distal end.

3. The chemiluminescent device cover (10) as described in claim 1, wherein the envelope (12) further comprises an envelope fastener (12B) to attach the at least one envelope flap (12A) thereto.

4. The chemiluminescent device cover (10) as described in claim 1, wherein the envelope (12) is manufactured from a material selected from a group consisting of fuzzy fabric, faux fur, plastic, and plastic composite.

5. The chemiluminescent device cover (10) as described in claim 1, wherein the chemiluminescent device is selected from a group consisting of stick, necklace, bracelet, and ring.
